(19) United States
(12) Patent Application Publication
(10) Pub. No.: US 2007/0101844 A1
(43) Pub. Date: May 10, 2007

(54) Punching device

(75) Inventor: Andreas Spilker, Detmold (DE)

Correspondence Address: BARNES & THORNBURG LLP, 750-17TH STREET NW, SUITE 900, WASHINGTON, DC, 20006-4675, US

(73) Assignee: Spilker GmbH

(21) Appl. No.: 11/270,540

(22) Filed: Nov. 10, 2005

(51) Int. Cl. B26D 1/56

(52) U.S. Cl. 83/344; 83/669

(57) ABSTRACT

A punching device includes a rotatably disposed punching cylinder and a rotatable counterpressure cylinder. A distance exists between the punching cylinder and the counterpressure cylinder, the distance being adjustable and in which distance a web of material is guidable therethrough. Also included is at least one elastic ring arranged on the counterpressure cylinder and used to adjust the distance. The punching cylinder is movable in a rolling motion on the at least one elastic ring.

### CROSS-REFERENCE

This non-provisional application claims priority to and benefit from German Patent Application No. 10 2004 054 868.4-26, filed in Germany on Nov. 12, 2004, the disclosure of which is hereby incorporated by reference herein.

### BACKGROUND AND SUMMARY

The present disclosure relates to a punching device, particularly for labels. The punching device includes a rotatably disposed punching cylinder and a rotatable counterpressure cylinder, between which a web of material can be guided therethrough. A distance exists between the punching cylinder and the counterpressure cylinder, which distance is adjustable.

From European Patent Document EP 899 068 A2, a device for punching labels is known, in the case of which a punching cylinder and a counterpressure cylinder are provided with cylinder bearers which roll on one another. In order to change the gap between the punching cylinders and the counterpressure cylinder, the cylinder bearers are arranged on the counterpressure cylinder on an eccentric section of an intermediate ring. By rotating the intermediate ring, the level of the cylinder bearer can be changed so that the distance of the punching cylinder from the axis of the counterpressure cylinder is changed. This adjusting mechanism has the disadvantage that the position of the cylinder bearers is changed during the adjusting, so that pressure rollers acting upon the cylinder bearers first have to be loosened in order to again set the desired prestressing force after the adjusting. The adjusting can therefore not take place during the running operation of the punching device.

From German Patent Document DE 103 05 032, a punching device is known in the case of which the counterpressure cylinder is disposed on an eccentric section of a shaft and the distance between the punching cylinder and the counterpressure cylinder can be changed by rotating the shaft. Although this permits an adjustment during the running operation, the manufacturing of the eccentric section requires comparatively high expenditures and costs.

The present disclosure relates to a punching device which permits an adjusting of the distance between the punching cylinder and the counterpressure cylinder by relatively simple devices.

Thus, the present disclosure relates to a punching device including a rotatably disposed punching cylinder and a rotatable counterpressure cylinder. A distance exists between the punching cylinder and the counterpressure cylinder, the distance being adjustable and in which distance a web of material is guidable therethrough. Also included is at least one elastic ring arranged on the counterpressure cylinder and used to adjust the distance. The punching cylinder is movable in a rolling motion on the at least one elastic ring.

According to the present disclosure and as noted above, at least one elastic ring is provided on the counterpressure cylinder for adjusting the distance between the punching cylinder and the counterpressure cylinder. The punching cylinder or a cylinder bearer connected with the punching cylinder moves in a rolling motion on the at least one elastic ring. As a result of the elasticity of the at least one elastic ring, the distance between the punching cylinder and the counterpressure cylinder can be adjusted slightly, in which case usually only slight adaptations of a few 0.01 mm are required. When the word “elasticity” is therefore mentioned in the present disclosure, a slight elasticity is usually sufficient for being able to correspondingly change the distance. The use of the at least one elastic ring may eliminate a necessity of producing eccentric components, which simplifies the production.

According to an illustrative embodiment of the present disclosure, the at least one elastic ring is disposed on a shaft of the counterpressure roller. The shaft may have an integral construction with the counterpressure cylinder, so that only a few components are required for producing the punching device.

For a reduction of forces, one elastic ring is arranged on both sides of the counterpressure roller. A high degree of parallelism with respect to the axis is thereby achieved.

In another illustrative embodiment, the at least one elastic ring is constructed in several parts and has an inner ring and an outer ring. The inner ring may have a higher elasticity than the outer ring, so that the outer ring can be produced of a hard material for a long service life. The inner ring includes a plastic material, such as polyamide. Other materials may, of course, also be used. The design of the at least one elastic ring depends on the adjusting demand to be expected.

In a further illustrative embodiment, the counterpressure cylinder is supported on the side situated opposite the punching cylinder. In this case, the supporting devices do not rest against the at least one elastic ring but adjacently rest against the counterpressure cylinder in order to ensure an effective reduction of force.

According to another illustrative embodiment, the at least one elastic ring has at least one cavity, so that the distance between an interior surface and the exterior surface of the at least one elastic ring can be slightly adjusted. The at least one cavity is formed by at least one ring-shaped groove arranged between the exterior surface and the interior surface. Such a groove can be produced by rotating the ring. In this case, at least one groove can be arranged on opposite sides of the ring, so that, in the cross-sectional view, the at least one elastic ring has an S-shape. As a result, when the at least one elastic ring is compressed, the exterior surface can be held parallel to the interior surface of the at least one elastic ring.

Other aspects of the present disclosure will become apparent from the following descriptions when considered in conjunction with the accompanying drawings.

### BRIEF DESCRIPTION OF THE DRAWINGS

FIG. 1 is a lateral view of a punching device, according to the present disclosure.

FIG. 2 is a frontal view of the punching device of FIG. 1.

FIG. 3 is a perspective view of a counterpressure cylinder of the punching device of FIG. 1.

FIG. 4 is a sectional front view of the counterpressure cylinder of FIG. 3.

FIGS. 5A, 5B are two different views of an embodiment of an elastic ring, according to the present disclosure.

### DETAILED DESCRIPTION

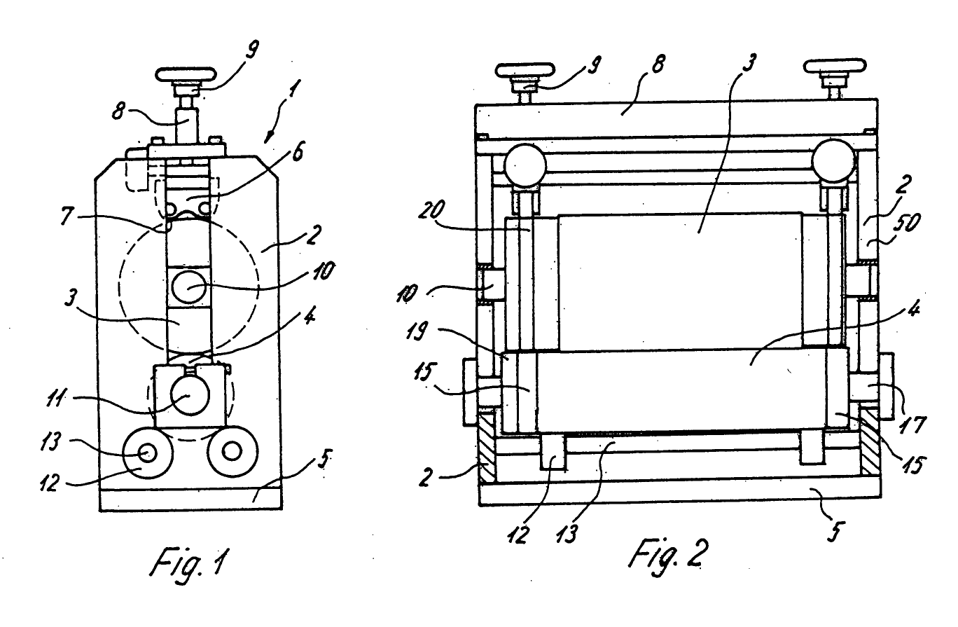

A punching device 1 illustrated in FIGS. 1 and 2 has a frame 2 on which a punching cylinder 3 and a counterpressure cylinder 4 are disposed. A web of material can be guided through between the punching cylinder 3 and the counterpressure cylinder 4, a punching of the web of material taking place by a corresponding profiling of the punching cylinder 3.

The frame 2 of the punching device 1 comprises a bottom 5, two side walls 50 and an upper connection piece 8.

Cylinder bearers 20 are provided on the punching cylinder 3 and, for a prestressing, are acted upon by a pressure piece 6 on which pressure rollers 7 are disposed. The pressure piece 6 can be moved relative to connection piece 8 by a handwheel 9 in order to press the pressure rollers 7 onto the cylinder bearers 20 on the punching cylinder 3.

The cylinder bearers 20 carry out a rolling motion on elastic ring 15, 16 on the counterpressure cylinder 4 which is disposed on a joint shaft 17 with the counterpressure cylinder 4. The punching cylinder 3 is disposed around a stationary but rotatable shaft 10 which is accommodated in the side walls 50 of the frame 2.

The counterpressure cylinder 4 is also disposed on the frame 2 by a shaft 17.

On a side facing away from the punching cylinder 3, the counterpressure cylinder 4 is supported on supporting rollers 12 which can be rotated about a shaft 13. The supporting rollers 12 are arranged adjacent to elastic ring 15, 16 and move directly on the counterpressure cylinder 4 in a rolling motion.

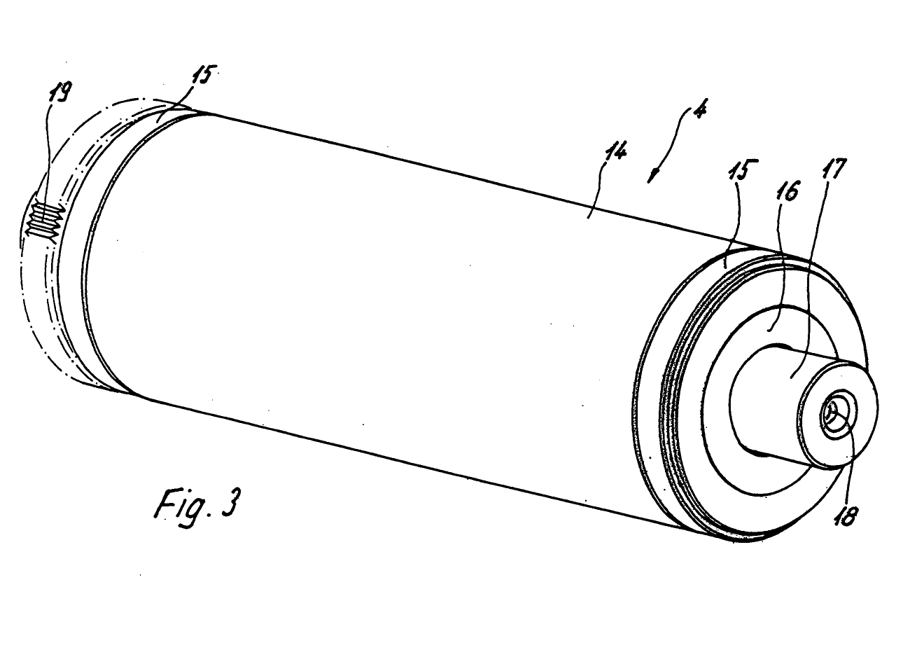

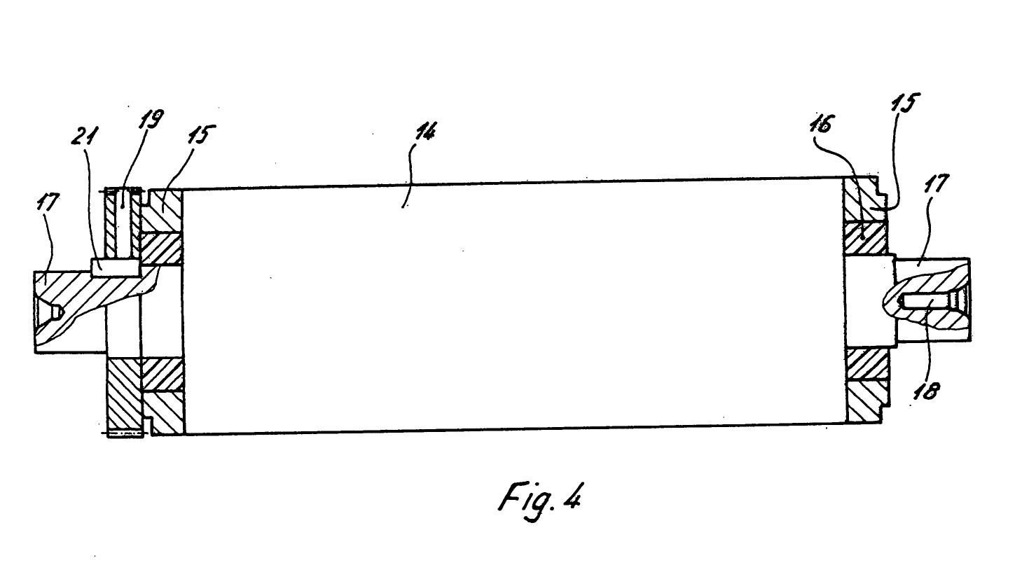

FIGS. 3 and 4 show the counterpressure cylinder 4. The counterpressure cylinder 4 comprises a cylindrical roller body 14 onto whose opposite faces integrally constructed shafts 17 are shaped. Inner ring 16, made of a plastic material, which may be polyamide, is disposed in a press fit on the shaft 17 adjacent to the roller body 14. Inner ring 16, in turn, is non-rotatably surrounded by outer ring 15, which may be made of steel.

The projecting shaft 17 is used for the bearing of the counterpressure cylinder 4. An opening 18 in the shaft 17 is provided for a centering.

A gearwheel 19 is disposed on one side of the shaft 17, which gearwheel 19 is non-rotatably connected with the counterpressure cylinder 4 by an adjusting spring 21. A gap is formed between the gearwheel 19 and the outer ring 15, so that the cylinder bearer 20 does not come in contact with the gear wheel 19.

For adjusting a distance 30 between the punching cylinder 3 and the counterpressure cylinder 4, a pressure force upon the pressure piece 6 is adjusted. For example, pressure upon the punching cylinder 3 can be increased, which punching cylinder 3 then transmits the pressure via cylinder bearers 20 upon elastic ring 15, 16. By increasing the pressure, the inner ring 16 made of polyamide is slightly compressed, so that the distance 30 between the punching cylinder 3 and the counterpressure cylinder 4 is reduced. An adjustment by only a few 0.01 mm is usually sufficient. However, if thicker webs of material are punched, a vertical adjustment can naturally also be larger. By arranging the supporting rollers 12 adjacent to the outer ring 15, the outer ring 15, when it is compressed, can move slightly away from an axis of rotation of the counterpressure cylinder 4 as well as yield downward, and a deformation of the outer ring 15 is avoided.

If the pressure on the pressure piece 6 is reduced, as a result of a slight expansion of the inner ring 16, the punching cylinder 3 moves upward, and the distance 30 is correspondingly enlarged.

In the illustrated embodiment, the elastic ring, as shown, for example in FIG. 3, is constructed in several parts, comprising outer ring 15 and an inner ring 16. It is also conceivable to provide a one-piece ring. Furthermore, the elastic ring may also be constructed of more than two rings, the elasticity being dependent on the amount of adjustment. Correspondingly, the inner ring 16 may have a larger or smaller cross-section in order to increase or decrease a maximal adjusting path. Instead of polyamide, other materials can also be used. A certain elasticity can also be achieved in that the elastic ring 15, 16 may be made of metal and have hollow chambers or ribs which permit a certain compression at a corresponding pressure.

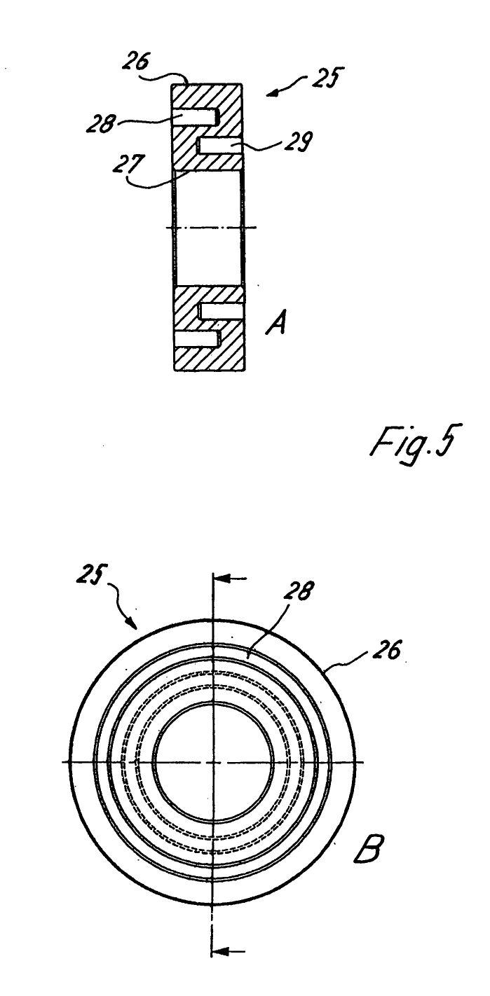

FIGS. 5A and 5B show an illustrative embodiment of an elastic ring 25, as it can be used in the punching device of FIGS. 1 and 2. Elastic ring 25 may replace the two rings 15 and 16.

The ring 25, which may be made of metal, such as steel, has an exterior surface 26 at an outer circumference, on which exterior surface 16 a cylinder bearer 20 can move in a rolling motion. An interior surface 27 of the ring 25 can be disposed on shaft 17. In order to ensure elasticity of the ring 25, ring-shaped grooves 28 and 29 are recessed in the ring 25 and are arranged on opposite sides. The grooves 28 and 29 each extend beyond a center plane of the ring 25, so that a cross-section of the ring 25 becomes S-shaped. As a result, when the ring 25 is compressed, the exterior surface 26 remains parallel to the interior surface 27.

Instead of two grooves 28 and 29, several grooves may also be provided on the ring 25. In addition, a closed cavity can be used for ensuring a certain elasticity.

In the illustrative embodiments, the counterpressure cylinder 4 is supported on the bottom 5. It is conceivable that the supporting devices 12 may be omitted and the counterpressure cylinder 4 may be held only by shafts 17. A drive of the punching device takes place by the gearwheel 19 on the counterpressure cylinder 4. It is also conceivable to arrange corresponding driving devices at different positions.

In the illustrative embodiments, the cylinder bearers 20 also move in a rolling motion on the elastic ring 15, 16, 25. It is also conceivable that the punching cylinder 3 moves in a rolling motion directly on the elastic rings 15, 16, 25 and can be moved vertically by the same adjusting mechanism.

Furthermore, it is conceivable to arrange the supporting rollers 12 on the elastic ring 15, 16. In this case, a certain deformation of the elastic ring 15, 16 may be accepted when an adjustment of the gap or distance 30 between the punching cylinder 3 and the counterpressure cylinder 4 takes place.

Although the present disclosure has been described and illustrated in detail, it is to be clearly understood that this is done by way of illustration and example only and is not to be taken by way of limitation. The scope of the present disclosure is to be limited only by the terms of the appended claims.

I claim:

1. A punching device, comprising:
a rotatably disposed punching cylinder;
a rotatable counterpressure cylinder;
a distance existing between the punching cylinder and the counterpressure cylinder, the distance being adjustable and in which distance a web of material is guidable therethrough;
at least one elastic ring arranged on the counterpressure cylinder and used to adjust the distance; and
wherein the punching cylinder is movable in a rolling motion on the at least one elastic ring.

2. The punching device according to claim 1, wherein the at least one elastic ring is disposed on a shaft of the counterpressure cylinder.

3. The punching device according to claim 1 wherein the at least one elastic ring is arranged on both sides of the counterpressure cylinder.

4. The punching device according to claim 1, wherein the at least one elastic ring is constructed in parts, having an inner ring and an outer ring surrounding the inner ring.

5. The punching device according to claim 4, wherein the inner ring has a higher elasticity than the outer ring.

6. The punching device according to claim 4, wherein the inner ring is made of a plastic material.

7. The punching device according to claim 4, wherein the outer ring is made of steel.

8. The punching device according to claim 1, wherein shafts for a bearing of the at least one elastic ring and of the counterpressure cylinder are integrally shaped onto the counterpressure cylinder.

9. The punching device according to claim 1, wherein the counterpressure cylinder is supported on a side opposite the punching cylinder (3), and supporting devices are arranged adjacent to the at least one elastic ring.

10. The punching device according to claim 1, wherein the at least one elastic ring includes at least one cavity and is resilient between an exterior surface and an interior surface of the at least one elastic ring.

11. The punching device according to claim 10, wherein the at least one cavity is formed by at least one ring-shaped groove arranged between the exterior surface and the interior surface.

12. The punching device according to claim 11, wherein at least one ring-shaped groove is arranged on opposite sides of the at least one elastic ring.

13. The punching device of claim 6, wherein the plastic material is polyamide.
